(19) United States
(12) Patent Application Publication
(10) Pub. No.: US 2016/0290811 A1
(43) Pub. Date: Oct. 6, 2016

(54) TRANSPORTATION MONITORING SYSTEM AND METHOD

(71) Applicant: General Electric Company, Schenectady, NY (US)

(72) Inventors: Ryan David WATTERSON, Atlanta, GA (US); Samuel Woerner BUEHNER, Atlanta, GA (US); Brandon PARKER, Atlanta, GA (US); Amir ALAVI, Atlanta, GA (US)

(21) Appl. No.: 14/990,812

(22) Filed: Jan. 8, 2016

Related U.S. Application Data
(60) Provisional application No. 62/143,127, filed on Apr. 5, 2015.

(51) Int. Cl. G01C 21/20; G06Q 10/08; G06F 3/0484; B61L 27/00

(52) U.S. Cl. CPC G01C 21/20; B61L 27/0011; G06Q 10/0833; G06F 3/0484

(57) ABSTRACT

A system for monitoring a transportation network includes one or more processors that are configured to determine origin and destination pairs for different vehicle systems formed from different groups of vehicles and traveling in a transportation network formed from interconnected routes, identify the vehicles included in the different vehicle systems, and display different graphical representations of the vehicle systems based on the vehicles included in the vehicle systems on a map of the transportation network that is displayed on a display device.

### CROSS-REFERENCE TO RELATED APPLICATIONS

This application claims priority to U.S. Provisional Application No. 62/143,127, which was filed on 5 Apr. 2015, and the entire disclosure of which is incorporated herein by reference.

### FIELD

Embodiments of the present disclosure generally relate to systems and methods for monitoring vehicles and routes within transportation networks.

### BACKGROUND

Some cargo shippers have issues of having to track each railcar of trains individually to capture statuses of a single shipment. Many of these shippers use unit trains, which have dedicated engine power to move railcars for only that shipper. For example, some shippers want to know what is happening with the cargo traffic of the shippers, across transportation networks utilized by the shippers. Some known cargo tracking systems focus on the details of individual railcars first, with a drill-up management of the information from individual railcars. This can involve tracking significant amounts of data and, as a result, some of the more important, high-level information can be lost to the shippers or be difficult to obtain in an expedient manner.

Additionally, tracking the details of railcar mileage has been a problem of the rail industry for decades. Many shippers lease railcars from private railcar owners, and the leases for these railcars can have mileage limitations and/or maintenance schedules that are based on the miles traveled by the railcars. Shippers may be required to incorporate mileage into the everyday planning of cargo shipments. Some shippers calculate railcar mileage in highly manual manners and these calculations typically are estimates at best.

The information that is used to track cars and cargo can be provided from a variety of sources, such as waybills, car location messages (CLMs), manifests, or the like. In some circumstances, this information can be communicated to a tracking system via a web service data feed. This type of web service communication can require two systems to communicate via a common schema that both system can recognize. A common schema may incorporate the data structure, parent/child hierarchy relationships, and data element names. Most systems, however, do not have identical formats. For example, the waybill or CLM may use a different name to refer to a location of a car than is used by a tracking system that receives the waybill or CLM data, the location of the car may be nested inside a different data hierarchy in the waybill or CLM than in the tracking system, etc. In order for the correct data in the waybill or CLM to be placed into the proper location in the tracking system to allow for the tracking system to monitor the cars or cargo, the data may need to be translated to enable the tracking system to understand and import the data. This can be a resource intensive task that is both costly and time consuming.

### BRIEF DESCRIPTION

In one embodiment, a system (e.g., a transportation monitoring system) includes one or more processors configured to receive data relating to vehicles associated with a transportation network formed from interconnected routes. The one or more processors are further configured, based at least in part on the data, to determine origin and destination pairs for different vehicle systems formed from different groups of the vehicles and traveling in the transportation network, to identify the vehicles included in the different vehicle systems, and to direct one or more display devices to display different graphical representations of the vehicle systems based on the vehicles included in the vehicle systems on a map of the transportation network that is displayed on one of the one or more display devices.

In one embodiment, a method (e.g., for monitoring a transportation network) includes determining origin and destination pairs for different vehicle systems formed from different groups of vehicles and traveling in a transportation network formed from interconnected routes, identifying the vehicles included in the different vehicle systems, and displaying different graphical representations of the vehicle systems based on the vehicles included in the vehicle systems on a map of the transportation network that is displayed on a display device.

In one embodiment, a method (e.g., for monitoring a transportation network) includes determining an origin location and a destination location for a trip of a cargo shipment, determining one or more modes of transportation of the cargo shipment from the origin location to the destination location, displaying a graphical representation of the cargo shipment from the origin location to the destination location on a display device, and one or more of: responsive to receiving an operator selection of at least part of the graphical representation of the cargo shipment, displaying information representative of a leg of the trip of the cargo shipment that is associated with the operator selection, and/or displaying different portions of the graphical representation of the cargo shipment in different manners representative of the one or more modes of transportation.

In one embodiment, a method (e.g., for monitoring a transportation network) includes receiving selection of one or more incoming data fields in an incoming data structure, the one or more incoming data fields representing different types of data that are provided by one or more data providers via a web service to a monitoring system, determining whether one or more of a name or hierarchy of the one or more incoming data fields that are selected are to be changed, and generating a mapped data structure comprising one or more mapped data fields. The one or more mapped data fields can correspond to the one or more incoming data fields that are selected with the one or more of the name or hierarchy that is determined to be changed. The mapped data structure can be used to determine which of the data provided by the one or more data providers are to be communicated to the monitoring system in the one or more mapped data fields.

In one embodiment, a method (e.g., for monitoring a transportation network) includes determining origin and destination pairs for different vehicle systems formed from different groups of vehicles and traveling in a transportation network formed from interconnected routes, identifying the vehicles included in the different vehicle systems, and displaying different graphical representations of the vehicle systems based on the vehicles included in the vehicle systems on a map of the transportation network that is displayed on a display device.

In another embodiment, another method (e.g., for monitoring a transportation network) includes determining an origin location and a destination location for a trip of a cargo shipment, determining one or more modes of transportation of the cargo shipment from the origin location to the destination location, displaying a graphical representation of the cargo shipment from the origin location to the destination location on a display device, and one or more of (a) responsive to receiving an operator selection of at least part of the graphical representation of the cargo shipment, displaying information representative of a leg of the trip of the cargo shipment that is associated with the operator selection and/or (b) displaying different portions of the graphical representation of the cargo shipment in different manners representative of the one or more modes of transportation.

In another embodiment, a system (e.g., a transportation monitoring system) includes one or more processors configured to determine origin and destination pairs for different vehicle systems formed from different groups of vehicles and traveling in a transportation network formed from interconnected routes, to identify the vehicles included in the different vehicle systems, and to direct one or more display devices to display different graphical representations of the vehicle systems based on the vehicles included in the vehicle systems on a map of the transportation network that is displayed on a display device.

In another embodiment, a system (e.g., a transportation monitoring system) includes one or more processors configured to determine an origin location and a destination location for a trip of a cargo shipment, to determine one or more modes of transportation of the cargo shipment from the origin location to the destination location, to direct one or more display devices to display a graphical representation of the cargo shipment from the origin location to the destination location, and to direct the one or more display devices to one or more of display information representative of a leg of the trip of the cargo shipment that is associated with an operator selection responsive to receiving an operator selection of at least part of the graphical representation of the cargo shipment or to display different portions of the graphical representation of the cargo shipment in different manners representative of the one or more modes of transportation.

### BRIEF DESCRIPTION OF THE DRAWINGS

The subject matter described herein will be better understood from reading the following description of non-limiting embodiments, with reference to the attached drawings, wherein below:

FIG. 1 illustrates one example of a vehicle system that may travel in a transportation network as described herein;

FIG. 2 illustrates one embodiment of a transportation monitoring system;

FIG. 3 illustrates one example of a display representation (or image) that may be presented to a user via the display device of the system shown in FIG. 2;

FIG. 4 illustrates another example of a display representation (or image) that may be presented to a user via the display device of the system shown in FIG. 2;

FIG. 5 illustrates another display representation (or image) of the transportation network shown in FIGS. 3 and 4 according to another embodiment;

FIG. 6 illustrates another graphical representation (or image) that may be displayed on the display device shown in FIG. 2 according to another embodiment;

FIG. 7 illustrates another display representation (or image) that may be displayed on the display device shown in FIG. 2 according to another embodiment;

FIG. 8 illustrates another display representation (or image) that may be displayed on the display device shown in FIG. 2 according to another embodiment;

FIG. 9 illustrates another display representation (or image) that may be displayed on the display device shown in FIG. 2 according to another embodiment;

FIG. 10 illustrates a flowchart of a method for monitoring a transportation network;

FIG. 11 illustrates a flowchart of another method for monitoring a transportation network;

FIG. 12 illustrates one embodiment of a data mapping system;

FIG. 13 illustrates a display or image shown on an output device of the mapping system shown in FIG. 12 according to one example;

FIG. 14 illustrates another example of a display or image shown on the output device of the mapping system shown in FIG. 12 according to one example; and

FIG. 15 illustrates a flowchart of one embodiment of a method for mapping data in one or more data streams to a customized and/or individualized data structure.

### DETAILED DESCRIPTION

Certain embodiments of the present disclosure provide systems and methods for displaying various aspects of a transportation network and/or vehicles moving within the transportation network. A transportation network can include interconnected routes, such as tracks, roads, waterways, paths in the air, or the like, over which vehicles can travel between various locations. These vehicles can include automobiles, rail vehicles, off-highway vehicles (e.g., mining vehicles or other vehicles that are not legally permitted or designed for travel on public roadways), marine vessels, airplanes, or the like. The transportation network can include two or more different types of routes, such as waterways that meet up with or otherwise intersect tracks or roads at a port, shipping locations (e.g., airports, warehouses, etc.) where tracks and roads meet up, or the like. The transportation network can extend over a large area and may include many vehicles concurrently traveling in the network. One or more embodiments of the inventive subject matter described herein provide for improved techniques for tracking and/or displaying movements, statuses, or the like, of the vehicles and/or routes in the transportation network.

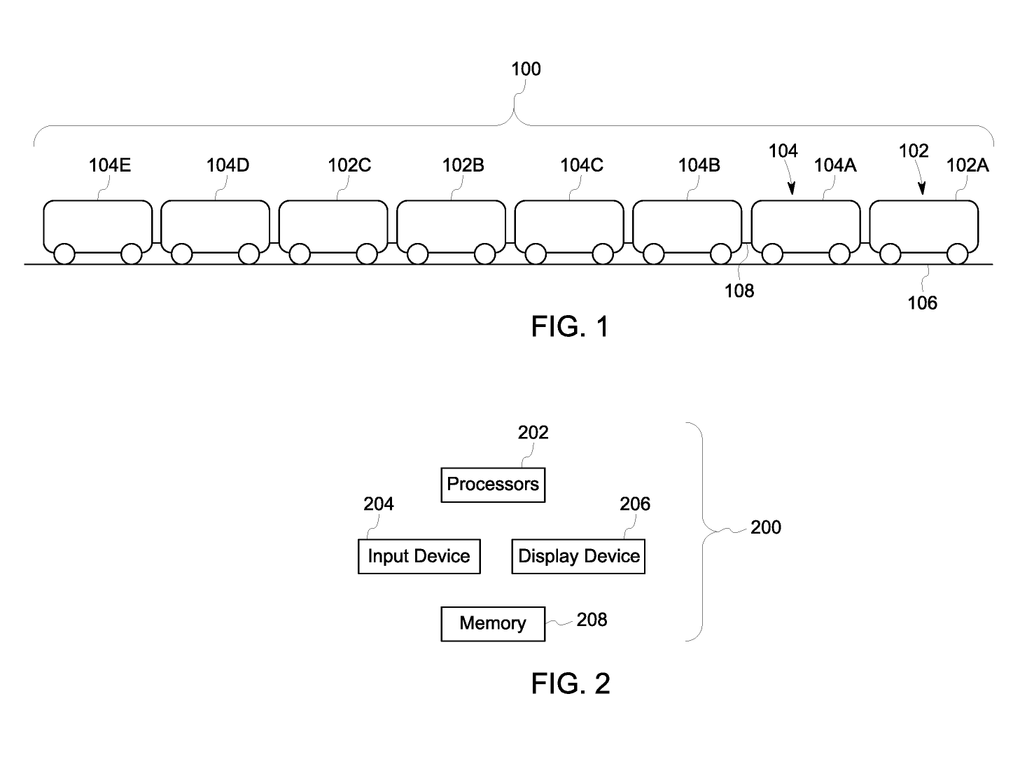

FIG. 1 illustrates one example of a vehicle system 100 that may travel in a transportation network as described herein. The vehicle system 100 includes multiple vehicles 102, 104 that travel together along one or more routes 106 of the transportation network. The vehicles 102 (e.g., units 102A-C) represent propulsion-generating vehicles that are capable of producing tractive effort to propel the vehicles 102. Examples of propulsion-generating vehicles 102 include locomotives, automobiles, trucks, marine vessels, airplanes, etc. The vehicles 104 (e.g., units 104A-E) represent non-propulsion-generating vehicles that are not capable of producing tractive effort. Examples of non-propulsion-generating vehicles 104 include rail cars, trailers, barges, or the like. The vehicles 102, 104 may be mechanically connected with each other, such as by couplers 108, to travel together as the vehicle system 100 along the routes 106. Alternatively, the vehicles 102, 104 may not all be mechanically connected with each other. For example, the vehicles 102 may be connected with the vehicles 104, but not with other vehicles 102, such that the vehicles 102 separately move the vehicles 104. The vehicles 102 may communicate with each other to coordinate their movements so that the vehicles 102, 104 move along the routes 106 together. One example of the vehicle system 100 includes a rail vehicle consist, such as a train. Optionally, the vehicle system 100 may represent a truck pulling one or more trailers, a boat pushing or pulling one or more barges, an airplane, etc. In one embodiment, the vehicle system 100 may not include the non-propulsion-generating vehicles 104.

FIG. 2 illustrates one embodiment of a transportation monitoring system 200. The system 200 includes one or more processors 202, which can represent hardware circuitry that includes and/or is connected with one or more processors, controllers, or other electronic logic-based devices. The system 200 also includes one or more input devices 204, such as a keyboard, electronic mouse, microphone, touchscreen, or the like. The system 200 includes one or more display devices 206, such as a monitor, television, smart phone, touchscreen (e.g., the same or different touchscreen as the input device 204), or the like. The system 200 also includes a memory 208, which can represent one or more computer hard drives, random access memories, read only memories, or the like. The processor 202 can perform various operations described herein based on computer readable instructions (e.g., software) that is stored on the memory 208 or in another location.

In one embodiment, the system 200 can provide for the monitoring and/or management of unit vehicles. A unit vehicle can include a vehicle system 100 (shown in FIG. 1) that travels from an origin location to a destination location in a transportation network to transport the same cargo from the origin location to the destination location. With respect to the vehicle system 100 shown in FIG. 1, the vehicle system 100 may be a unit vehicle when all of the vehicles 102, 104 in the vehicle system 100 travel from the same starting location to the same destination location in a trip. The vehicle system 100 may not be a unit vehicle when one or more of the vehicles 102 and/or 104 are added to or removed from the vehicle system 100 at a location where the other vehicles 102, 104 are not added to or removed from the vehicle system 100. For example, a vehicle system 100 traveling in a trip from Chicago, Ill. to San Francisco, Calif. that begins the trip with all of the vehicles 102, 104 in Chicago and ends the trip with all of the same vehicles 102, 104 in San Francisco can be a unit vehicle, while a vehicle system 100 that begins the trip with all of the vehicles 102, 104 in Chicago but picks up one or more additional vehicles 102, 104 and/or removes one or more vehicles 102, 104 from the vehicle system 100 in a location between Chicago and San Francisco may not be a unit vehicle.

Alternatively, the content of a unit vehicle may be altered during a trip. For example, instead of the unit vehicle having the same vehicles 102, 104 for an entire trip, the unit vehicle may have vehicles 104 added and/or removed at one or more locations between an origin location of a trip and a destination location of the trip. In contrast, a manifest vehicle includes a vehicle that is completely dismantled upon arrival at a major yard or junction located between origin and destination locations of a trip. The individual vehicles 104 are re-combined onto one or more new manifest vehicles based on the destinations of the individual vehicles 104. Unit vehicles can be altered at the same locations, but typically maintain the vast majority of the vehicles 104 in the unit vehicles. A vehicle can maintain the same vehicle identification throughout a trip, whereas a manifest vehicle may be broken up and re-built with each new manifest vehicle receiving a new vehicle identification.

Some entities that transport cargo from one location to another (which may be referred to herein as “shippers”) previously may have had to track each vehicle 104 individually in order to monitor the status of a cargo shipment being carried by the vehicles 104. The status of the shipment can include the location of the vehicles 104 carrying the cargo along the routes 106, an estimated and/or scheduled time of arrival of the vehicles 104 at the destination location and/or one or more intermediate locations, a health or damage to the vehicles 104, among other information.

In one aspect, the system 200 may monitor the status of the entire unit vehicle 100 and present this information to a user of the system 200. The vehicles 102, 104 that are included in the vehicle 100 may be provided to the system 200 via the input device 204 and stored in the memory 208, but only the status of the entire unit vehicle 100 may be provided to the user via the display device 206.

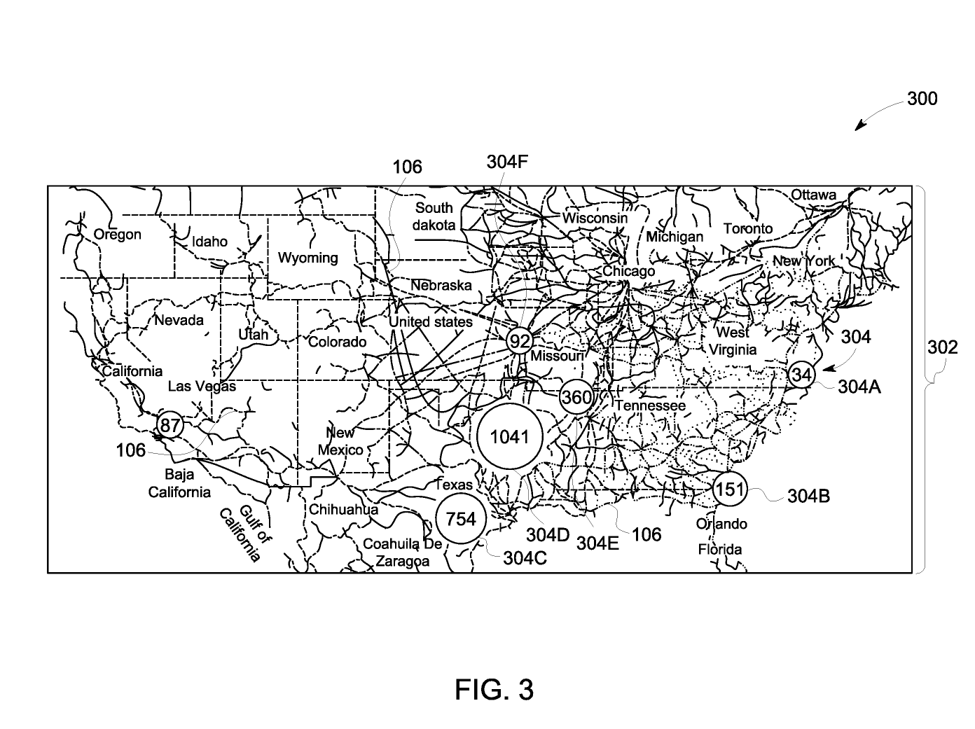

FIG. 3 illustrates one example of a display representation 300 (or image) that may be presented to a user via the display device 206 of the system 200 shown in FIG. 2. The display representation 300 can be created by the processor 202 (shown in FIG. 2) and displayed on the display device 206. The display representation 300 illustrates a transportation network 302 formed by several interconnected routes 106. Only three routes 106 are labeled in FIG. 3, but the transportation network 302 may include more routes 106, fewer routes 106, or a single route 106.

Several graphical representations 304 (e.g., graphical representations 304A-F) are shown in the display representation 300. The graphical representations 304 can include icons that represent different vehicle systems 100 traveling in the transportation network 302. In one aspect, the graphical representations 304 represent different unit vehicles 100. The graphical representations 304 can be displayed in different sizes, colors, or other appearances to indicate differences between the unit vehicles 100. For example, the graphical representations 304 may be larger for unit vehicles 100 having a larger number of vehicles 102 and/or 104 and smaller for unit vehicles 100 having a smaller number of vehicles 102 and/or 104. Optionally, the graphical representations 304 may include numbers or other indicia to indicate the number of vehicles 104 (and/or vehicles 102) in the unit vehicle 100. For example, the graphical representation 304D may be larger than other graphical representations 304 and/or may include the number “1041” because the graphical representation 304D represents a unit vehicle 100 having 1,041 vehicles 104 while the other unit vehicles 100 have fewer vehicles 104.

A user of the system 200 may view or otherwise obtain additional details about the vehicle systems 100 represented by one or more of the graphical representations 304. As one example, the input device 204 may be used to select a graphical representation 304. In response to this selection, the processor 202 can obtain additional information about the vehicle system 100 associated with the selected graphical representation 304 from the memory 208 or elsewhere, and cause the display device 206 to present this information.

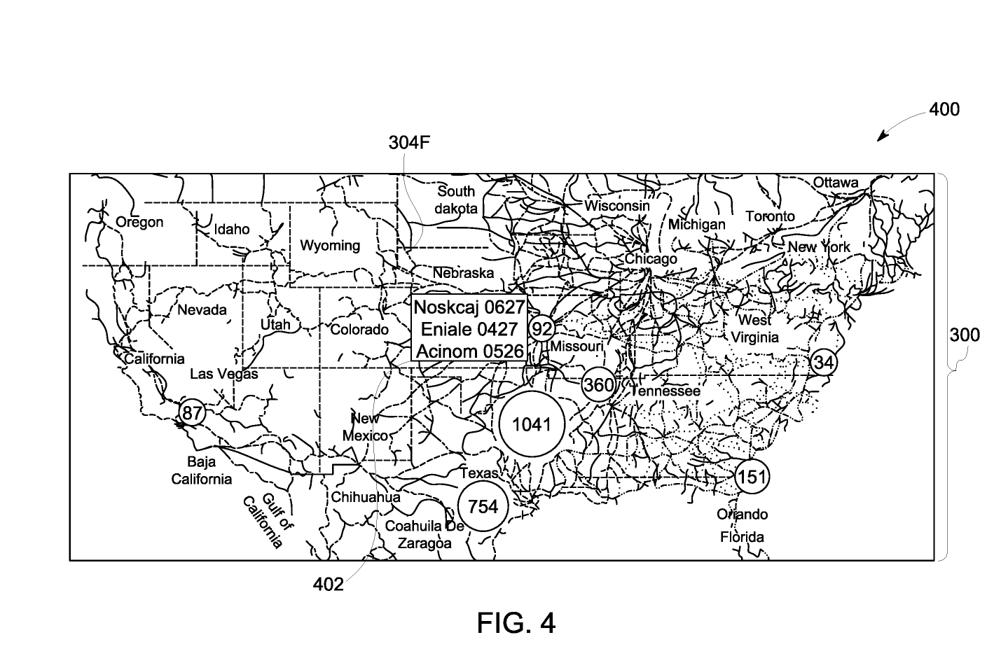

FIG. 4 illustrates another example of a display representation 400 (or image) that may be presented to a user via the display device 206 of the system 200 shown in FIG. 2. The display representation 400 can be created by the processor 202 (shown in FIG. 2) and displayed on the display device 206. The display representation 400 illustrates the transportation network 302. The display representation 400 includes an information display 402, which presents additional information about one or more of the vehicle systems 100 (shown in FIG. 1) represented by a selected graphical representation 304.

For example, in response to a user employing the input device 204 to select the graphical representation 304F during presentation of the display representation 300 shown in FIG. 3, the processor 202 may obtain and direct the display device 206 to present the information display 402. The information display 402 can include additional information about the vehicle system 100 represented by the graphical representation 304F selected by the user, such as a list of vehicles 102 and/or 104 in the vehicle system 100, the origin location of the vehicle system 100, the destination location of the vehicle system 100, the estimated and/or scheduled time of arrival of the vehicle system 100, the cargo being carried by the vehicles 104, mileage of the vehicle system 100, mileage of individual vehicles 104, mileage of individual vehicles 102, or the like.

The processor 202 can generate user-customizable rules for use in identifying which vehicles 104 are included in the different vehicle systems 100. For example, a user may employ the input device 204 to identify which vehicles 104 are included in a vehicle system 100, such as by selecting the vehicles 104 from a list, by specifying a type of the vehicles 104 (e.g., by the manufacturer, model number, or the like, of the vehicle 104), by specifying a cargo being carried by the vehicles 104, etc. Based on this identification, the processor 202 can examine a list, table, or other memory structure in the memory 208 to identify which vehicles 104 match, meet, or otherwise satisfy the criteria or criterion provided by the user. The user-provided criteria optionally may include a spatial sequence of the vehicles 104 in a vehicle system 100, such as where the vehicles 104 are located within the vehicle system 100 relative to each other. The processor 202 may then “build” the vehicle system 100, such as by associating the vehicles 104 that match, meet, or otherwise satisfy the user-provided criteria or criterion.

In one aspect, one or more of the criteria used by the processor 202 to determine which vehicles 104 are included in a vehicle system 100 may be based on a history of previous vehicles 104 included in the same vehicle system 100 for one or more previous trips of the vehicle system 100. For example, if the same thirty vehicles 104 are included in the same vehicle system 100 at least a designated number of times (with the designated number being greater than one), then the processor 202 may identify these vehicles 104 as forming a baseline group of vehicles 104. The processor 202 may then automatically include these same vehicles 104 in the vehicle system 100 for future trips of the vehicle system 100 when the vehicles 104 are available for inclusion in the vehicle system 100 (e.g., the vehicles 104 are at the same origin location for a trip of the vehicle system 100).

The processor 202 can store these criteria that are used to identify which vehicles 104 are included in a vehicle system 100, such as in the memory 208 or another location. The processor 202 can use the criteria to automatically determine which vehicles 104 are included in a vehicle system 100, to automatically determine the spatial sequence of the vehicles 104 in the vehicle system 100, to automatically add and/or remove vehicles 104 to the vehicle system 100 (e.g., when additional vehicles 104 matching the criteria are added to or removed from the memory 208, the vehicles 104 can automatically be added to or removed from a vehicle system 100), or the like.

The routes 106 may be presented in different manners on the display device 206. Different graphical representations of the routes 106 can include displaying the routes 106 in different colors, with different types of lines (e.g., dashed, solid, different types of dashes, etc.), with lines of different thicknesses, or the like. For example, the routes 106 can be displayed as differently colored lines that overlay a map, as shown in FIGS. 3 and 4. The different colors used for the routes 106 can indicate different ownership of the routes 106, different types of routes 106, or other differences between the routes 106. For example, all routes 106 that are owned or maintained by the same entity (e.g., company or government) may be displayed using the same color, type of line, or the like, while other routes 106 that are owned or maintained by other entities may be displayed using other colors, line types, or the like. As another example, all routes 106 of the same class (e.g., Federal Railroad Administration track classifications) may be displayed as the same color, or the routes 106 of one class may be displayed in one color, while all other routes 106 (even routes 106 in different classes) are displayed in the same, but different color. In one aspect, the graphical representations 300, 400 generated by the processor 202 and shown on the display device 206 show one type of routes 106 (e.g., rail lines or tracks), but not other types of routes 106 (e.g., roads).

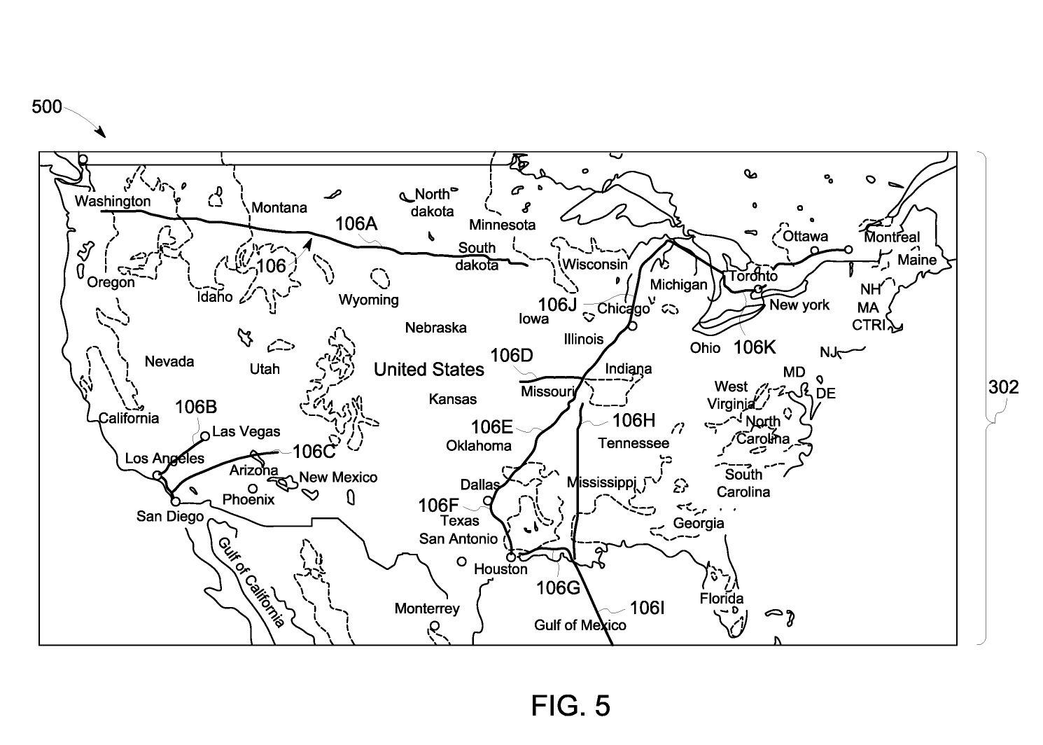

FIG. 5 illustrates another display representation 500 of the transportation network 302 shown in FIGS. 3 and 4 according to another embodiment. In contrast to the graphical representations 300, 400, the display representation 500 does not display as many routes 106 in the transportation network 302 as are shown in the graphical representations 300, 400. For example, the graphical representations 300, 400 may show all of the routes 106 in the transportation network 302, the routes 106 of a selected type or class (e.g., as selected by a user of the system 200) but not all routes 106, or the routes 106 of another subset (but not all routes 106). The display representation 500 may display a smaller number of the routes 106.

For example, the display representation 500 may only display routes 106A-J instead of the many more routes 106 shown in the graphical representations 300, 400 in FIGS. 3 and 4. The processor 202 may select a group of routes 106A-J for display based on which routes 106 are currently being traveled and/or are scheduled to be traveled by vehicle systems 100. As a result, the display representation 500 may only display those routes 106 that are currently being traveled and/or that are scheduled to be traveled by designated vehicle systems 100. A user of the system 200 may identify a group of vehicle systems 100 and/or the system 200 may automatically identified this group of vehicle systems 100 and, in response, the processor 202 may direct the display device 206 to display the routes 106 being currently traveled and/or that are scheduled to be traveled by these vehicle systems 100. The vehicle systems 100 that are identified may be identified based on whether or not the vehicle systems 100 meet one or more criteria, such as the type of cargo being carried by the vehicle systems 100, the mileage of the vehicle systems 100, the size of the vehicle systems 100 (e.g., the number of vehicles 102 and/or 104, the weight, etc.), or the like.

The routes 106 that are displayed in one or more of the graphical representations 300, 400, 500 may include different types of routes 106. For example, the routes 106A-H and 106K can represent over-land routes (e.g., tracks, roads, or the like), while the routes 1061-J can represent water based routes or air routes.

Some users of the system 200 may desire to monitor the status of a shipment of cargo from an origin location to a destination location, but may not necessarily want to monitor this status by individually tracking movements of individual vehicles 104. The vehicle system or systems 100 carrying the cargo can be selected automatically (e.g., based on criteria as described herein) and/or based on user input. The processor 202 may then examine locations of these vehicle systems 100 (e.g., based on locations communicated from the vehicle systems 100 to the processor 202, based on locations monitored by signals or other wayside devices that determine when the vehicle systems 100 pass locations of the signals or wayside devices, based on schedules of the vehicle systems 100, etc.) and determine which routes 106 are being traveled or scheduled to be traveled by the vehicle systems 100. The identification of these routes 106 may be completed by the processor 202 examining a route database or other memory structure in the memory 208 or elsewhere, and comparing locations of the vehicle systems 100 with locations of the routes 106 stored in the route database. Based on this comparison, the processor 202 can determine which routes 106 are being currently traveled on or scheduled to be traveled on by the vehicle systems 100. The processor 202 may direct the display device 206 to display these routes 106 and no other routes 106. As a result, these routes 106 are displayed to a user so that the user can more easily visualize which routes 106 are being traveled by the vehicle systems 100 that are of interest to the user.

Optionally, the processor 202 may direct the display device 206 to display the routes 106 that are historically traveled by the vehicle systems 100 of interest to a user. The processor 202 may examine which routes 106 are traveled at least a designated number of times within a designated time period by one or more vehicle systems 100 that are manually selected by the user and/or that are automatically selected based on criteria, as described above. For example, the processor 202 can identify routes 106 that are traveled at a frequency that is greater than a designated frequency (e.g., traveled more than five times within the last month) by the selected vehicle systems 100. The processor 202 may direct the display device 206 to display these routes 106 and no other routes 106. As a result, these routes 106 are displayed to a user so that the user can more easily visualize which routes 106 are frequently traveled by the vehicle systems 100 that are of interest to the user.

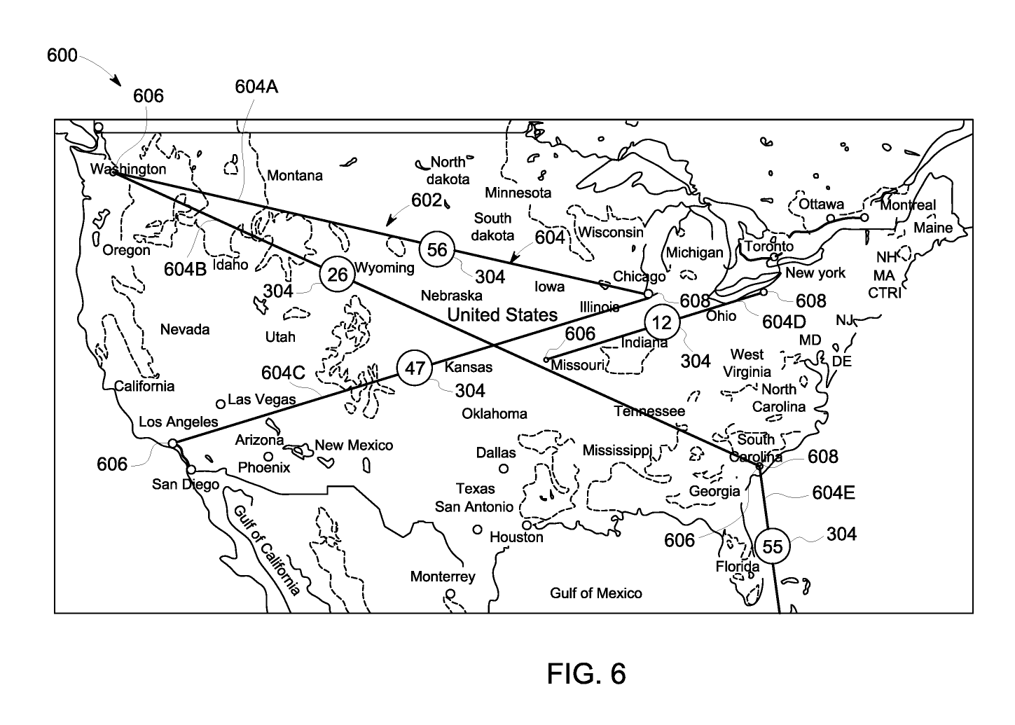

FIG. 6 illustrates another graphical representation 600 that may be displayed on the display device 206 shown in FIG. 2 according to another embodiment. The graphical representation 600 may be generated by the processor 202 shown in FIG. 2 directing the display device 206 also shown in FIG. 2 to display origin/destination (O/D) pairs for trips of selected vehicle systems 100 (shown in FIG. 1). An O/D pair represents a set of a starting, or origin, location of a trip and a final ending, or destination, location of the same trip. Optionally, the O/D pair may include one or more additional intermediate locations.

The memory 208 (shown in FIG. 2) may store trips of vehicle systems 100, such as the O/D pairs, scheduled times of departure from the origin location, scheduled and/or estimated times of arrival at the destination location, the vehicle systems 100 traveling or scheduled to travel in the trips, etc. The processor 202 can obtain information about trips of the vehicle systems 100 and determine the O/D pairs for the trips. The processor 202 may direct the display device 206 to display linear representations 602 in the graphical representation 600 to represent the trips of the vehicle systems 100. The linear representations 602 may include lines 604 (e.g., lines 604A-E) that directly connect an origin location 606 and a destination location 608 for each trip of one or more vehicle systems 100. The linear representations 602 may not extend along or indicate the shape of the path of the route or routes 106 used by the vehicle system 100 to travel from the origin location to the destination location. For example, the routes 106 along which a vehicle system 100 travels from an origin location to a destination location likely includes curves, twists, undulations, etc. (as shown in the graphical representations 300, 400, 500 of FIGS. 3 through 5), and are not perfectly linear paths. Instead of displaying the routes 106 with the curves, twists, undulations, and the like, the processor 202 may direct the display device 206 to present the paths taken or scheduled to be taken by the vehicle systems 100 from origin locations 606 to destination locations 608 of the trips. Alternatively, the trips may be represented by shapes other than lines.

Some locations are origin locations 606 for two or more trips of different vehicle systems 100. For example, the lines 604A, 604B represent different trips for different vehicle systems 100 having the same origin location 606 but different destination locations 608. Some locations are destination locations 608 for two or more trips of different vehicle systems 100. For example, the lines 604A, 604C represent different trips for different vehicle systems 100 having different origin locations 606 but the same destination location 608. Some locations may be an origin location 606 for one trip and also a destination location 608 for another trip. For example, the trip represented by the line 604B has a destination location 608 that is the same location as the origin location 606 for the trip represented by the line 604E. Other locations may only be a single origin or destination location for a single trip.

In the illustrated embodiment, the graphical representations 602 of the trips may include the graphical representations 304 on or near the lines 604. As described above, the graphical representations 304 can include icons that represent different vehicle systems 100 traveling in the transportation network 302. In one aspect, the graphical representations 304 represent different unit vehicles 100. The graphical representations 304 can be displayed in different sizes, colors, or other appearances to indicate differences between the unit vehicles 100. For example, the graphical representations 304 may be larger for unit vehicles 100 having a larger number of vehicles 102 and/or 104 and smaller for unit vehicles 100 having a smaller number of vehicles 102 and/or 104. Optionally, the graphical representations 304 may include numbers or other indicia to indicate the number of vehicles 104 (and/or vehicles 102) in the unit vehicle 100.

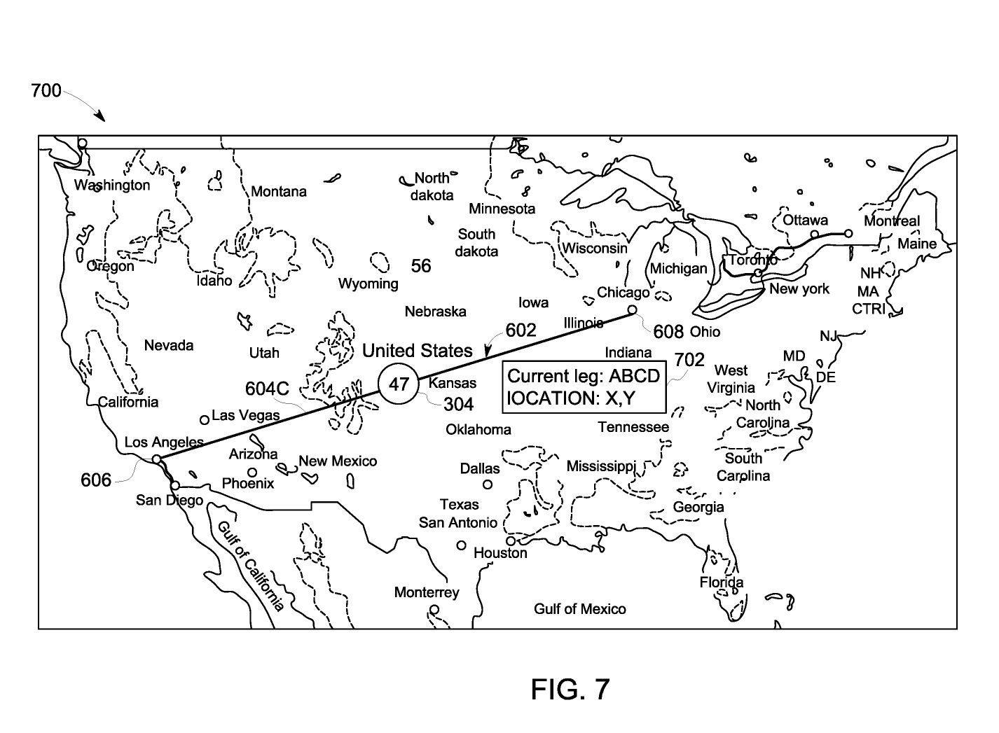

FIG. 7 illustrates another display representation 700 that may be displayed on the display device 206 shown in FIG. 2 according to another embodiment. The display representation 700 may be generated by the processor 202 shown in FIG. 2 directing the display device 206 also shown in FIG. 2 to display an information display 702. The information display 702 can present additional information about one or more of the vehicle systems 100 (shown in FIG. 1) represented by a selected graphical representation 304 and/or a selected graphical representation 602.

For example, in response to a user employing the input device 204 to select the graphical representation 304 associated with the graphical representation 604C and/or selecting the graphical representation 604C, the processor 202 may obtain and direct the display device 206 to present the information display 702. The information display 702 can include additional information about the vehicle system 100 represented by the graphical representation 604C selected by the user, such as the current location of the vehicle system 100, the current leg of the trip of the vehicle system 100, a list of vehicles 102 and/or 104 in the vehicle system 100, the origin location of the vehicle system 100, the destination location of the vehicle system 100, the estimated and/or scheduled time of arrival of the vehicle system 100, the cargo being carried by the vehicles 104, mileage of the vehicle system 100, mileage of individual vehicles 104, mileage of individual vehicles 102, or the like. The leg of the trip can represent a segment of a trip that the vehicle system 100 is currently traveling along. Different legs of the trip can include different fractions, distances, or segments of the trip. In one aspect, different legs are identified based on the transportation modality used in the different legs. One leg of a trip may involve cargo being transported by one or more automobiles, another leg of a trip may involve the same cargo being transported by one or more rail vehicles, or the like.

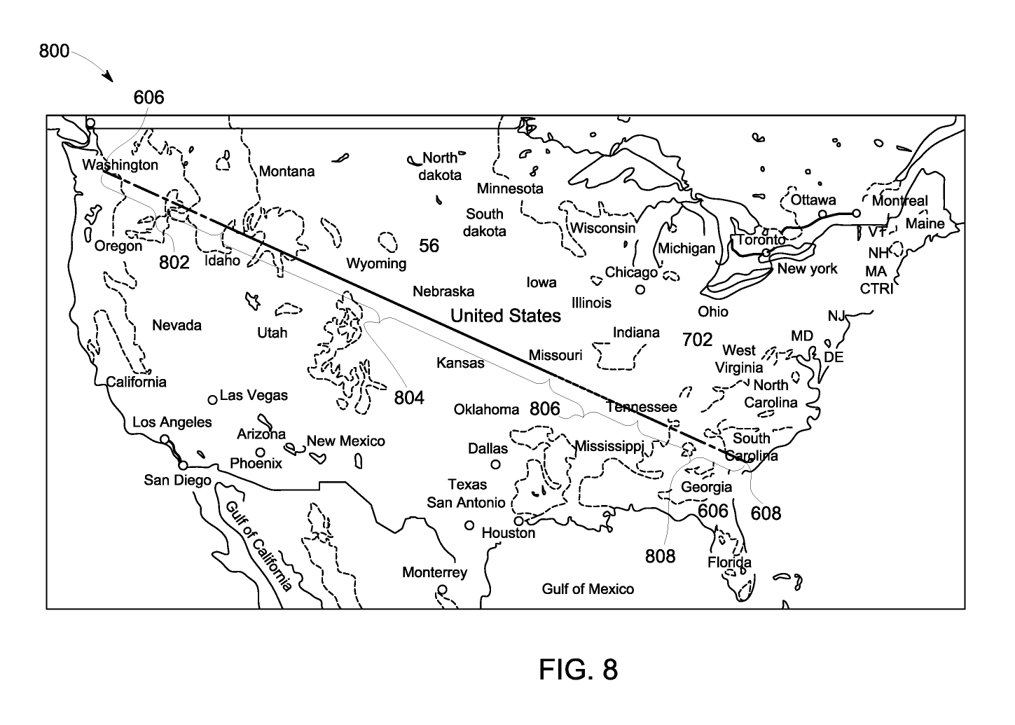

FIG. 8 illustrates another display representation 800 that may be displayed on the display device 206 shown in FIG. 2 according to another embodiment. The display representation 800 may be generated by the processor 202 shown in FIG. 2 directing the display device 206 also shown in FIG. 2 to display different legs 802, 804, 806, 808 of a trip in different ways.

In response to a graphical representation being selected (e.g., manually or automatically), such as the graphical representation 604B, the processor 202 can direct the display device 206 to display different legs of the trip represented by the linear representation 604B with different colors, different types of lines (e.g., solid, different dashes, etc.), or in another different manner. The lengths of the different legs may reflect the percentage or fraction of the distance of the associated leg relative to a total length of the trip. Optionally, the lengths of the different legs may reflect the percentage or fraction of the time scheduled or expected to travel the associated leg of the trip relative to a total time of the trip.

Returning to the description of the system 200 shown in FIG. 2, the processor 202 optionally may monitor mileage of the vehicle systems 100 and/or the individual vehicles 102 and/or 104. Some entities (e.g., shippers) may lease vehicles 104 other entities (e.g., private railcar owners), and the leases can have mileage limitations or maintenance schedules based on the miles traveled by the leased vehicles 104. Additionally or alternatively, some vehicles 102 and/or 104 may have recommended maintenance schedules that dictate which repairs and/or inspections are to be completed at different accumulations of miles traveled by the vehicles 102 and/or 104.

In order to assist in the tracking of miles traveled by the vehicle systems 100, vehicles 102, and/or vehicles 104 during a current trip and/or over several trips, the processor 202 may track historical and/or current mileage for each vehicle 102, 104 and present this information to users of the system 200 via the display device 206. The processor 202 can determine estimated initial mileage based on a scheduled route 106 (e.g., obtained from a user, a waybill, or the like) of a trip and/or a presumed usage of the scheduled route 106. The presumed usage of the route 106 may include a fraction, percentage, or the like, of the trip that will actually extend along the scheduled route 106. Due to repairs, maintenance, slow orders, traffic, or the like, the vehicle system 100 may deviate from the route 106 in the trip for a portion of the trip. The scheduled route 106 can be obtained from a schedule of the vehicle system 100 stored in the memory 208, from a user via the input device 204, or the like.

The processor 202 can determine actual mileage based on the actual route 106 traveled by the vehicle system 100 in a trip and/or the actual usage of the route 106. The actual route 106 and/or the actual usage of the route 106 may be determined based on the actual locations that the vehicle systems 100 traveled and reported to the processor 202 (or that were obtained by the processor). While a vehicle system 100 is traveling along a route 106 for a trip, the processor 202 can determine the remaining mileage for the vehicle system 100.

The processor 202 can determine accumulated mileage for individual vehicles 102 and/or 104 based on the actual mileage traveled by the vehicle systems 100 and the vehicles 102 and/or 104 included in the different vehicle systems 100. For example, the processor 202 can calculate an accumulated mileage for a railcar by adding the actual mileage of the vehicle systems 100 that included the railcar. The processor 202 may determine historical mileage for individual vehicles 102 and/or 104 by determining the accumulated mileage for the vehicle 102 and/or 104 during a designated time period.

Any or all of the preceding determined mileages can be stored in the memory 208 and/or presented to the user of the system 200 on the display device 206.

The processor 202 optionally may monitor how closely or far a vehicle system 100 travels off of the scheduled trip of the vehicle system 100. For example, the processor 202 can obtain a scheduled time of arrival of a vehicle system 100 at a destination location or other location from a schedule of the vehicle system 100, from input received via the input device 204, from a trip manifest, or the like. The processor 202 can monitor locations of the vehicle system 100 during the trip to determine how far behind or ahead of schedule the vehicle system 100 is traveling. Based on the scheduled time of arrival and how far ahead or behind schedule the vehicle system 100 is traveling, the processor 202 can calculate or estimate an estimated time of arrival. The estimated time of arrival and/or the scheduled time of arrival can be displayed on the display device 206. If the estimated time of arrival is later than the scheduled time of arrival or is later than the scheduled time of arrival by a designated, non-zero time threshold, then the processor 202 can generate an alert to the user that is displayed on the display device 206 or that is communicated to a device of the user (e.g., a mobile phone, tablet computer, or the like).

The processor 202 optionally may communicate alerts to users based on other events. For example, when a shipment is behind schedule or experiences another exception, the processor 202 may display an alert on the display device 204, email an alert to an email address of a user, send a text message to a user, or the like.

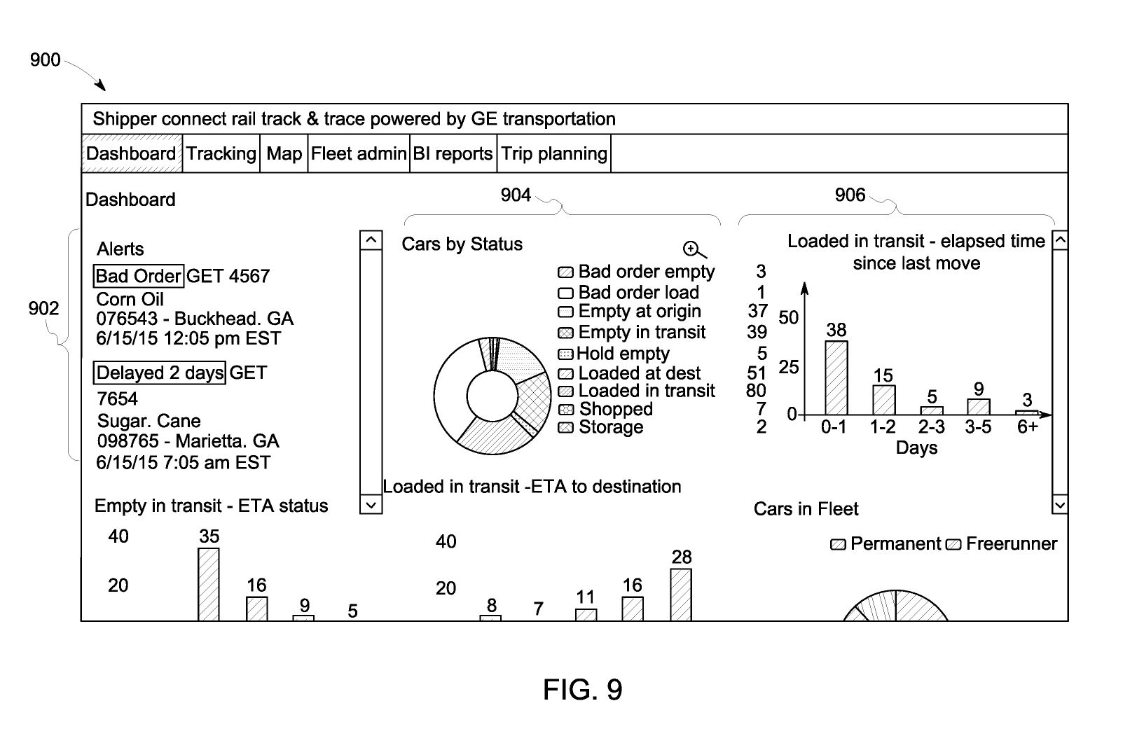

FIG. 9 illustrates another display representation 900 that may be displayed on the display device 206 shown in FIG. 2 according to another embodiment. The processor 202 can direct the display device 206 to present the display representation 900. The representation 900 may provide a dashboard to a user that indicates alerts 902, such as shipments that are behind schedule, how far behind schedule or delayed the shipments are, etc. The display representation 900 can include a status summary 904 of the vehicles 104, which can summarize the statuses of the vehicles 104, such as how many vehicles 104 are loaded with cargo, how many vehicles 104 are empty of cargo, how many vehicles 104 are stationary, how many vehicles 104 in storage, or the like. The display representation 900 may include a transit summary 906 of the vehicles 104, which can summarize how long it has been since the vehicles 104 have been stationary (e.g., in terms of days, weeks, months, etc.). Additionally summaries may be shown on the display device 206, such as a summary of estimated times of arrival of vehicles 104 that are not carrying cargo, a summary of estimated times of arrival of vehicles 104 that are carrying cargo, how many vehicles 104 are in a fleet of vehicles 104., etc.

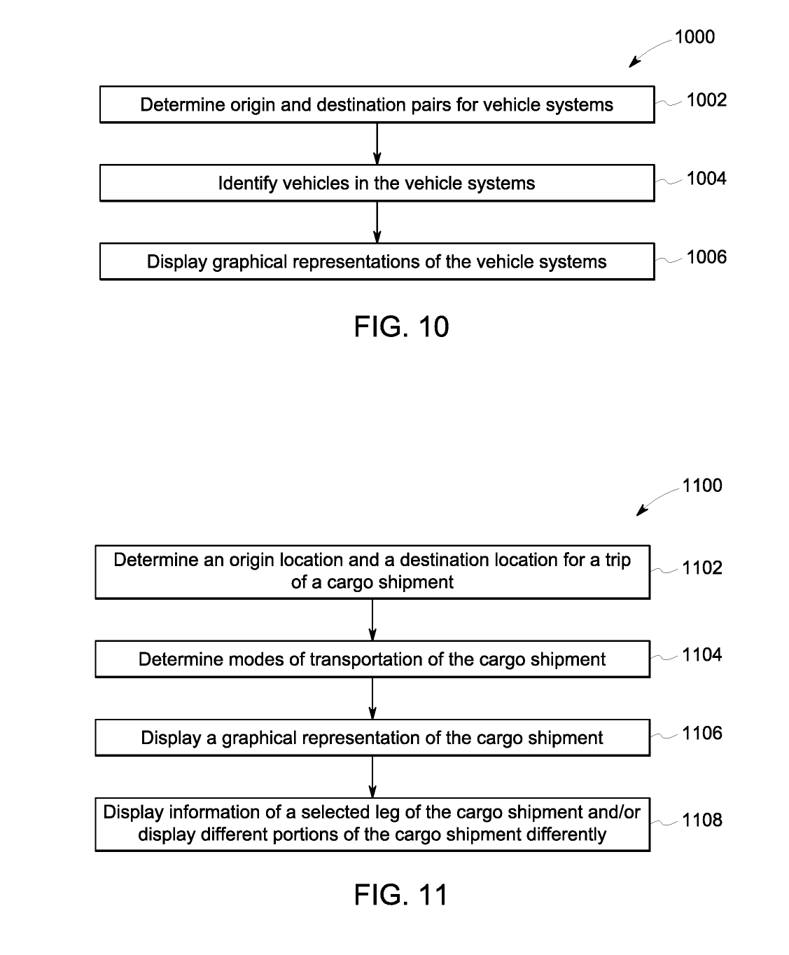

FIG. 10 illustrates a flowchart of a method 1000 for monitoring a transportation network. The method 1000 may be used to monitor and display information about vehicle systems traveling in a transportation system. At 1002, origin and destination pairs are determined for vehicle systems formed from different groups of vehicles and traveling in a transportation network formed from interconnected routes. At 1004, the vehicles included in the different vehicle systems are identified, such as by the processor 202 shown in FIG. 2 determining which vehicles 102 and/or 104 are included in the vehicle systems 100 from information stored in the memory 208 shown in FIG. 2. At 1006, different graphical representations of the vehicle systems are presented in a display on a display device based on the vehicles included in the vehicle systems. The representations can be displayed on a map of the transportation network that is displayed on the display device.

FIG. 11 illustrates a flowchart of another method 1100 for monitoring a transportation network. The method 1100 may be used to monitor and display information about vehicle systems traveling in a transportation system. At 1102, an origin location and a destination location for a trip of a cargo shipment are determined. At 1104, one or more modes of transportation of the cargo shipment from the origin location to the destination location are determined. For example, the processor 202 can determine which legs of the cargo shipment will be transported using marine vessels and/or over marine pathways, which legs of the cargo shipment will be transported using airborne vessels and/or over airways, which legs of the cargo shipment will be transported using rail vehicles and/or over tracks, and/or which legs of the cargo shipment will be transported using automobiles and/or over roads.

At 1106, a graphical representation of the cargo shipment from the origin location to the destination location is displayed on a display device. At 1108, the method 1100 includes one or more of displaying information representative of a leg of the trip of the cargo shipment that is associated with an operator selection and/or displaying different portions of the graphical representation of the cargo shipment in different manners representative of the one or more modes of transportation. The displaying the information representative of the leg of the trip and/or displaying the different portions of the graphical representation of the cargo shipment may occur responsive to receiving an operator selection of at least part of the graphical representation of the cargo shipment.

While the description of the different data and graphical representations included herein focuses on the vehicle systems 100, optionally, the data, representations, or the like, can represent the vehicles 102 and/or 104 included in the vehicle systems 100.

One or more embodiments of the systems and methods described herein optionally can provide a tool that allows users of the systems and methods to define individualized data structures for a data feeds. For example, users can customize XML data feeds to acquire data used to track movements of cars and/or cargo via one or more web service data feeds. The systems and methods can define a standard or designated data template for a data feed. This data feed can be a CLM data feed, a waybill data feed, or another type of data feed. The systems and methods can be used to manipulate various data fields, hierarchy and structure of the data fields, the names of the data fields, etc. to create a customized format for the data received via the data feed. The customized format can be saved, and data received from data feeds generated from one or more source systems are mapped (e.g., converted) from the standard template (e.g., the template used by the source systems) to the customized format, and the converted data can be passed to the end user's system for use in tracking cars and/or cargo, or for other uses.

The mapping systems and methods described herein reduce the typically resource and time intensive task of data communication/integration between two external systems. The systems and methods enable users to define and configure data formats (e.g., XML data formats) within a web application, and translate the data to customized formats defined by users.

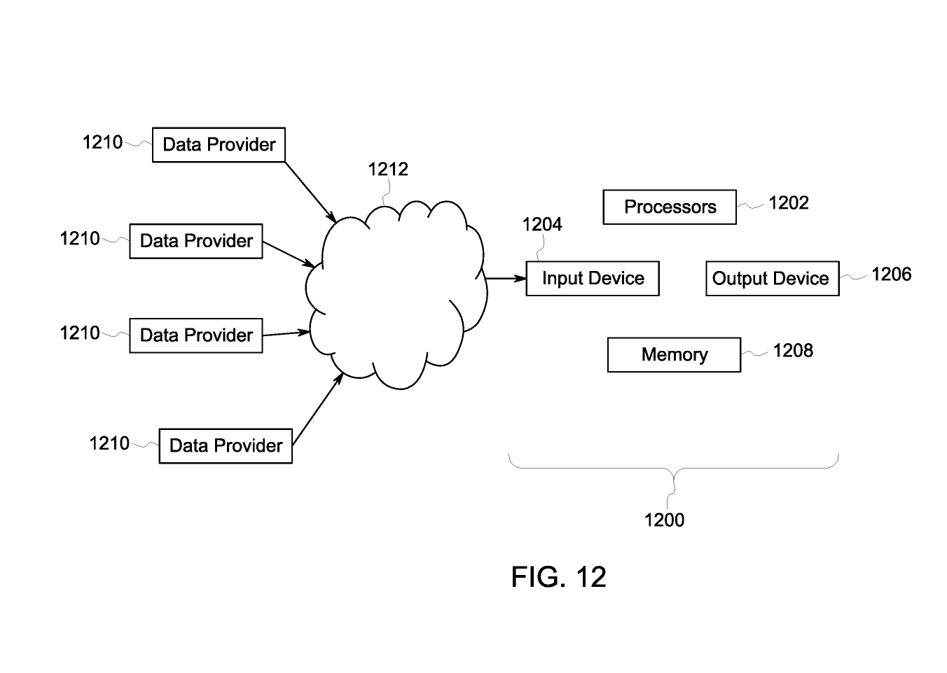

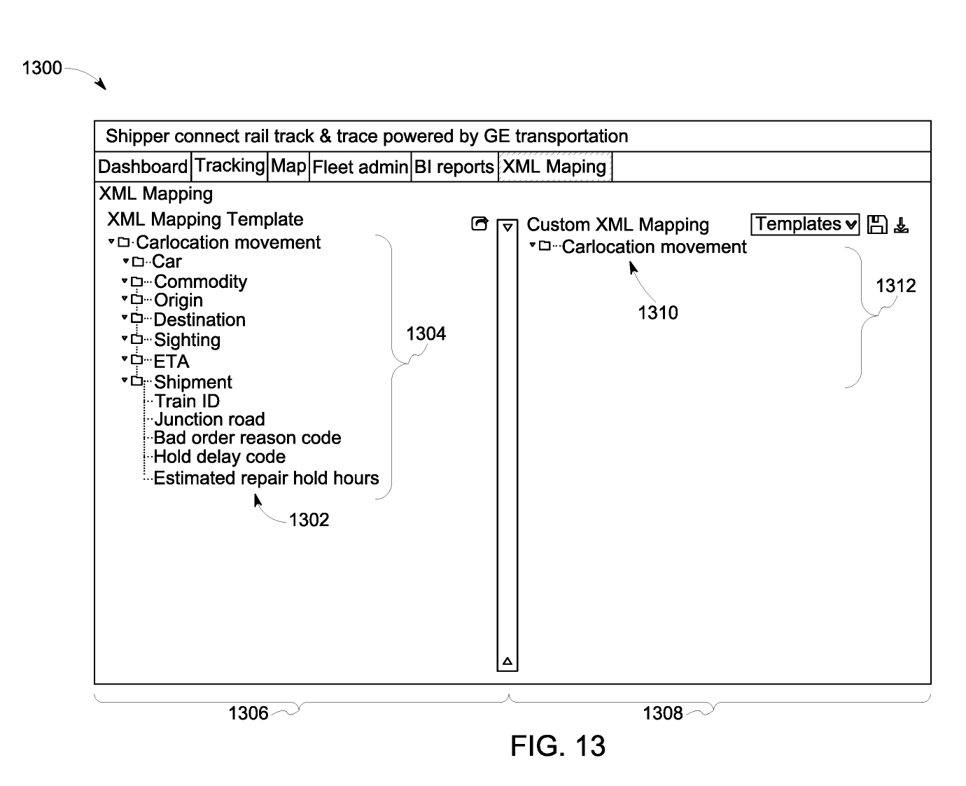

FIG. 12 illustrates one embodiment of a data mapping system 1200. The system 1200 may be used in conjunction with the transportation monitoring system 200 shown in FIG. 2, and/or may be incorporated into the system 200. For example, the mapping techniques described herein as being performed by the system 1200 may be performed by the system 200.

The system 1200 includes one or more processors 1202, which can represent hardware circuitry that includes and/or is connected with one or more processors, controllers, or other electronic logic-based devices. The system 1200 includes one or more input devices 1204, such as a keyboard, electronic mouse, microphone, touchscreen, or the like. The system 1200 includes one or more display devices 1206, such as a monitor, television, smart phone, touchscreen (e.g., the same or different touchscreen as the input device 204), or the like. The system 1200 also includes a memory 1208, which can represent one or more computer hard drives, random access memories, read only memories, or the like. The processor 1202 can perform various operations described herein based on computer readable instructions (e.g., software) that is stored on the memory 1208 or in another location.

The system 1200 can allow a user to customize a data feed, such as an XML data feed, received from a web service. The data feed may provide data used to track the movement of vehicles and/or cargos (as described herein). The data feed may provide the data from various providers 1210 (“Data Providers” in FIG. 12) to the system 1200 via one or more networks 1212, such as the Internet, one or more internets, intranets, or the like. For example, one or more other systems, sensors, dispatch facilities, or the like, can provide data to the system 1200 via the network 1212. The data includes information provided within a data structure that defines data fields for the data. The data fields represent names that can be provided to different types of data. For example, a location of a vehicle may be provided within a data field titled “Location,” “Postal Code,” “State,” or the like. An identity of a train in which a vehicle is included may be provided in a data field titled “TrainID.” Some data fields are nested within other data fields in a hierarchy defined by the data structure. For example, within a data field titled “Car,” several other data fields may be included that are filled with data representative of information about the vehicle identified within the “Car” field. These other data fields can include, by way of example, a starting location for the vehicle (e.g., an “Initial” data field), an identity of the vehicle (e.g., a “Number” data field), an indication of whether the vehicle is carrying cargo (e.g., a “LoadEmptyStatus” data field), etc. The data streams may provide different data within the same data fields from the same or different data providers 1210 to the system 1200.

The system 1200 can map the data in the data structures of the streams received from the providers 1210 to a data structure that is customized and/or individualized for the system 1200. Such a data structure may differ from data structures from one or more, or all, other systems that receive the data streams for use in tracking movements of vehicles and/or cargo.

FIG. 13 illustrates a display or image 1300 shown on the output device 1206 of the mapping system 1200 shown in FIG. 12 according to one example. The display 1300 can represent the image shown on the output device 1206 as a user of the system 1200 is creating a customized mapping of data fields 1302 in a data structure 1304 in which data provided in the data streams from the providers 1210. The display 1300 is generated by the processor 1202 (shown in FIG. 12) for presentation on the output device 1206.

The display 1300 includes an incoming data structure window 1306 representative of the different incoming data fields 1302 in which the incoming data from the providers 1210 may be received. The incoming data fields 1302 include, by way of example, a CarLocationMovement data field, which can include additional data fields, such as Car, Commodity, Origin, and the like, data fields 1302. Some data fields 1302 may be nested or included within other data fields 1302. For example, the TrainID, JunctionRoad, BadOrderReasonCode, HoldDelayCode, and EstimatedRepairHoldHours data fields 1302 may be included within the Shipment data field 1302. The hierarchy of the data structure 1304 defines these data fields 1302 to be nested within the Shipment data field 1302. Other data fields 1302 and/or data structures 1304 (other than those shown in FIG. 13) may be used. Not all data feeds may provide data for all of the data fields 1302 shown in the window 1304.

The display 1300 also includes a mapped data structure window 1308. The mapped data structure window 1308 includes one or more mapped data fields 1310. The mapped data fields 1310 can be associated with, but different from, the incoming data fields 1302. For example, the data included in an incoming data field 1302 may be included in a mapped data field 1310, with the mapped data field 1310 having a different location and/or name in a mapped data structure 1312 formed from the mapped data fields 1310.

In order to create the mapped data structure 1312, the user may employ the input device 1204 to select one or more of the data fields 1302 in the incoming data structure 1304. The user may then provide input using the input device 1204 to include the selected data field 1302 in the mapped data structure 1312. For example, the user may select the data field 1302 by clicking or otherwise selecting the data field 1302 in the incoming data structure window 1306 and moving the data field 1302 across the display 1300 to the mapped data structure window 1308. The user may change the name of the data field 1302 to a different name for the data field 1310 by double clicking on the data field 1302 in the mapped data structure window 1308 (or otherwise indicating that the name of the data field 1302 is to be changed), and then typing or otherwise providing the new name for the data field 1302 in the data field 1310.

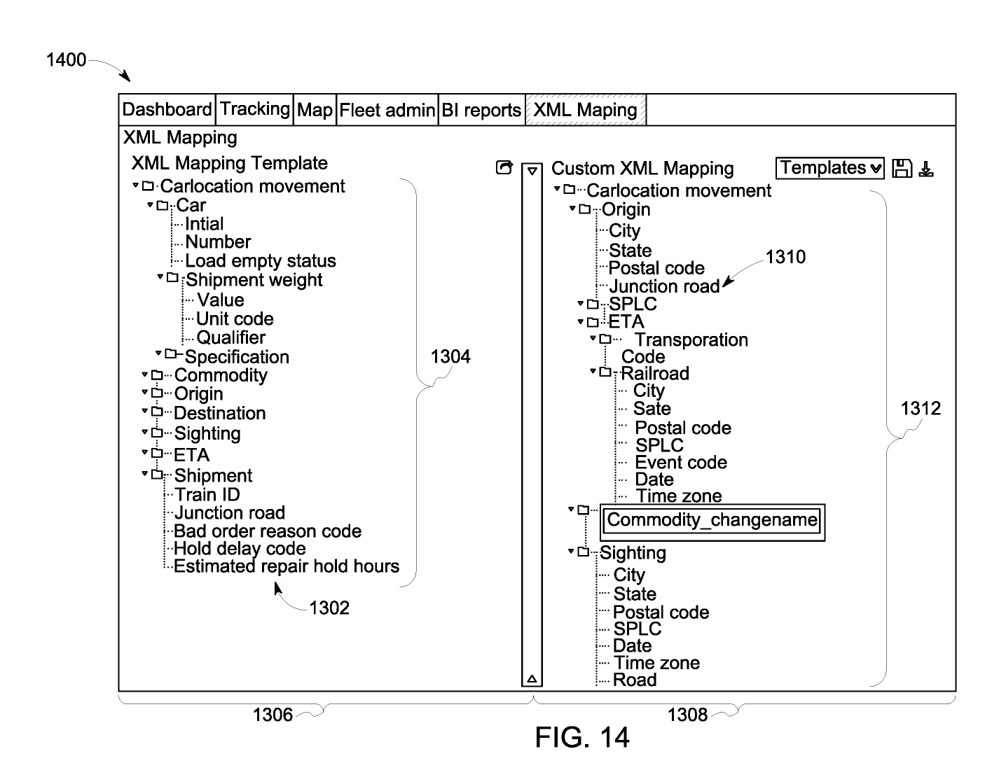

FIG. 14 illustrates another example of a display or image 1400 shown on the output device 1206 of the mapping system 1200 shown in FIG. 12 according to one example. The display 1400 is generated by the processor 1202 (shown in FIG. 12) for presentation on the output device 1206. The display 1400 includes several incoming data fields 1302 in the incoming data structure 1304 of the incoming data structure window 1306 and several mapped data fields 1310 in the mapped data structure 1312 of the mapped data structure window 1308. The user may create the mapped data structure 1312 by selecting and moving a set of some, but not necessarily all, of the data fields 1302 in the incoming data field structure 1304 to the mapped data field structure 1312. Upon moving a data field 1302 from the incoming structure 1304 to the mapped structure 1312, the data field 1302 becomes a mapped data field 1310.

Not all incoming data fields 1302 need to be included in the mapped data structure 1312. In the illustrated example, some of the data fields 1302 in the incoming data structure 1304 are not included in the mapped data structure 1312, such as the “Car,” “ShipmentWeight,” and other data fields 1302. Optionally, the user may use the system 1200 to change which data fields 1302 are included in other data fields 1302, and/or change names of the data fields 1302. For example, instead of the “Value” data field 1302 being included in (e.g., nested within the hierarchy) the “ShipmentWeight” data field 1302 in the mapped structure 1312, the user may use the system 1200 to place the “Value” data field 1302 outside of any other data field 1310 or inside another data field 1310 in the mapped structure 1312. As shown in the mapped data structure window 1308 in FIG. 13, the user optionally can change the name of a data field 1302 as a data field 1310. For example, the user can change the name of the “Commodity” data field 1302 to a “Commodity_changename” data field 1310 in the mapped data structure 1312.

In operation, the user can select, move, and optionally rename one or more of the incoming data fields 1302 to the mapped data structure 1312 as mapped data fields 1310. The mapped data structure 1312 can be saved (e.g., in the memory 1208 shown in FIG. 12) and used to map incoming data from data feeds generated by the providers 1210 (shown in FIG. 12) to the mapped data structure 1312. The table below lists several incoming data fields 1302 and corresponding mapped data fields 1310, along with the changes used by the user to map the incoming data fields 1302 to the mapped data fields 1310. The first column in the table lists the original incoming data field 1302, the second column in the table lists the mapped data field 1310 that corresponds with the incoming data field 1302 in the same row, and the third column in the table lists the change implemented to map the incoming data field 1302 to the mapped data field 1310 in the same row. Not all data fields 1302 shown in the Figures are included in the table.

| Incoming | | |
|---|---|---|
| data field (1302) | Mapped data field (1310) | Change |
| Car | Vehicle | Changed name |
| Initial | | |
| Number | Number | Changed hierarchy |
| LoadEmpty Status | CargoStatus | Changed name |
| ShipmentWeight | ShipmentWeight | None |
| Value | Value | None |
| UnitCode | | |
| Qualifier | | |

In the example represented by the table, the “Car” data field 1302 is included in the mapped data structure 1312 as a mapped data field 1310 having a different name of “Vehicle” and the “LoadEmptyStatus” data field 1312 is included in the mapped data structure 1312 as a mapped data field 1310 having a different name of “CargoStatus.” The “Initial,” “UnitCode,” and “Qualifier” data fields 1302 are not included in the mapped data structure 1312. The “Number” data field 1302 is included in the mapped data structure 1312 with the same name, but the hierarchy of the “Number” data field 1302 is changed in the mapped data structure 1312 so that the “Number” data field 1310 is outside of and not included or nested in the “Vehicle” data field 1310.

As a result, when data streams are sent from the providers 1210 that include data in the data fields 1302 that are mapped to the mapped data structure 1312, the appropriate data is provided to the system 1200 and/or the system 200 shown in FIG. 2 using the mapped data fields 1310. For example, data sent from the providers 1210 in the “Car” data field 1302 will be included in the “Vehicle” data field 1310, data sent from the providers 1210 in the “Initial” data field 1302 will not be included in any data field 1310, data sent from the providers 1210 in the “Number” data field 1302 will be included in the “Number” data field 1310 (but not within the “Vehicle” data field 1310), data sent from the providers 1210 in the “LoadEmptyStatus” data field 1302 will be included in the “CargoStatus” data field 1310, data sent from the providers 1210 in the “ShipmentWeight” data field 1302 will be included in the “ShipmentWeight” data field 1310, data sent from the providers 1210 in the “Value” data field 1302 will be included in the “Value” data field 1310, and data sent from the providers 1210 in the “UnitCode” or “Qualifier” data fields 1302 will not be included in any data fields 1310. The system 1200 and/or 200 can then use the data in the mapped data field 1312 to track movement and/or statuses of the vehicles and/or cargo, as described herein. In response to receiving data in a data stream from one or more of the providers 1210, the processor 1202 can identify which incoming data field that different data are included in and which mapped data field that the incoming data field corresponds to. The processor 1202 may then provide the data in the mapped data field to the systems or components that use the data, such as the system 200.

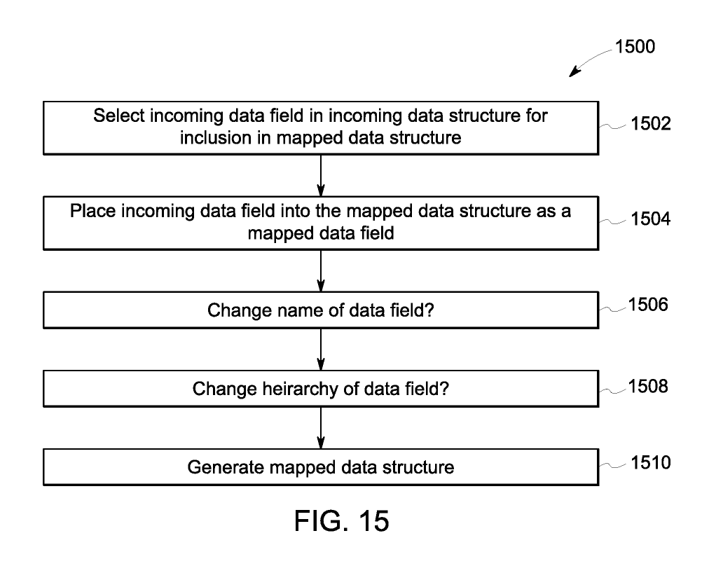

FIG. 15 illustrates a flowchart of one embodiment of a method 1500 for mapping data in one or more data streams to a customized and/or individualized data structure. The method 1500 may be used by one or more of the systems described herein to modify the data received in a data structure provided by one or more data providers into a data structure used by the systems for various purposes, such as for the tracking and/or monitoring of vehicles and cargo traveling in a transportation network. At 1502, one or more incoming data fields are selected. The data fields may be selected for inclusion in a mapped data field structure. For example, not all of the possible data fields in which data may be received in a data stream may be selected for use by a system. The data fields selected for inclusion in the mapped data structure represent the types of data that will be received and/or used by the systems.

At 1504, the incoming data field that is selected is placed into the mapped data structure as a mapped data field. The mapped data fields that are included in the mapped data structure may be saved in a memory of the system. At 1506, a determination is made as to whether the name of the data field selected for inclusion in the mapped data structure is to be changed. For example, a determination may be made as to whether a user chose to change the name of the mapped data field from the name used in the incoming data field. If the name is to be changed, then the user can provide a new name or the system can provide a name to the mapped data field (e.g., a default name). If the name is not to change, then the name of the mapped data field can be the same as the incoming data field.

At 1508, a determination is made as to whether the hierarchy of the data field selected for inclusion in the mapped data structure is to be changed. For example, a determination may be made as to whether a user chose to change whether the data field selected for inclusion in the mapped data structure is to be included within (e.g., nested within) another data field. If the hierarchy is to be changed, then the user can provide a new hierarchy for the mapped data field (e.g., a default heirarchy). If the hierarchy is not to change, then the hierarchy of the mapped data field can be the same as the incoming data field.

At 1510, the mapped data structure is generated. The mapped data structure can associate the selected data fields, which may have different names and/or hierarchies, with the incoming data fields. The structure can be saved in a memory and, responsive to receiving data provided in the incoming data fields, the mapped data structure can select which data are to be communicated in the mapped data structure, as well as the names and hierarchies of the data fields.

The subject matter described herein and the subject matter recited in the claims address a challenge of tracking many different cars and cargos being transported in a wide geographical area. This challenge is particular to the transportation industry in the modern era, especially with respect to the large number of cars concurrently traveling in the United States at any given time. The ability to monitor and track cars and cargos as described herein cannot be performed as purely mental steps by a human being within a commercially reasonable time period. Instead, the use of specially programmed computer devices (e.g., programmed according to the description herein) to receive and/or translate data as a web service, generate displays, etc., to track the movements of many cars and cargos may be required. The methods and systems described herein do not merely describe performance of a previously known business practice as the tracking of such a large number of cars and cargos, as well as visually presenting this information in a clear and informative way, previously was unobtainable without the subject matter described in this application. One or more embodiments of the methods and systems described herein are necessarily rooted in computer technology in order to overcome a problem specifically arising in the realm of transportation networks.

In one embodiment, a system (e.g., a transportation monitoring system) includes one or more processors configured to receive data relating to vehicles associated with a transportation network formed from interconnected routes. The one or more processors are further configured, based at least in part on the data, to determine origin and destination pairs for different vehicle systems formed from different groups of the vehicles and traveling in the transportation network, to identify the vehicles included in the different vehicle systems, and to direct one or more display devices to display different graphical representations of the vehicle systems based on the vehicles included in the vehicle systems on a map of the transportation network that is displayed on one of the one or more display devices.

In one aspect, the one or more processors are configured to determine the origin and destination pairs for the vehicle systems, for at least one of the vehicle systems, by identifying an origin location where the vehicles in the vehicle system begin a trip to a destination location and a destination location where the vehicles in the vehicle system end the trip.

In one aspect, the one or more processors are configured to direct the one or more display devices to display the graphical representations of the vehicle systems by displaying one or more of different sized representations or differently colored representations for the different vehicle systems.

In one aspect, the one or more processors are configured to receive an operator selection, via one or more input devices, of at least one of the graphical representations via an input device and, responsive to receiving the operator selection, the one or more processors are configured to direct the display device to display information representative of the vehicles in the vehicle system associated with the operator selection of the at least one of the graphical representations.

In one aspect, the one or more processors are configured to identify the vehicles by determining a baseline group of the vehicles included in at least one of the vehicle systems based on one or more of an operator-customized criterion or a history of one or more previous trips of the vehicles.

In one aspect, the one or more processors also are configured to direct the one or more display devices to display different graphical representations of the routes of the transportation network on the map that is displayed on the display device.

In one embodiment, a method (e.g., for monitoring a transportation network) includes determining origin and destination pairs for different vehicle systems formed from different groups of vehicles and traveling in a transportation network formed from interconnected routes, identifying the vehicles included in the different vehicle systems, and displaying different graphical representations of the vehicle systems based on the vehicles included in the vehicle systems on a map of the transportation network that is displayed on a display device.

In one aspect, determining the origin and destination pairs for the vehicle systems includes, for at least one of the vehicle systems, identifying an origin location where the vehicles in the vehicle system begin a trip to a destination location and a destination location where the vehicles in the vehicle system end the trip.

In one aspect, displaying the graphical representations of the vehicle systems includes displaying one or more of different sized representations or differently colored representations for the different vehicle systems.

In one aspect, the method also includes receiving an operator selection of at least one of the graphical representations via an input device and, responsive to receiving the operator selection, displaying information representative of the vehicles in the vehicle system associated with the operator selection of the at least one of the graphical representations.

In one aspect, identifying the vehicles includes determining a baseline group of the vehicles included in at least one of the vehicle systems based on one or more of an operator-customized criterion or a history of one or more previous trips of the vehicles.

In one aspect, the method also includes displaying different graphical representations of the routes of the transportation network on the map that is displayed on the display device.

In one embodiment, a method (e.g., for monitoring a transportation network) includes determining an origin location and a destination location for a trip of a cargo shipment, determining one or more modes of transportation of the cargo shipment from the origin location to the destination location, displaying a graphical representation of the cargo shipment from the origin location to the destination location on a display device, and one or more of: responsive to receiving an operator selection of at least part of the graphical representation of the cargo shipment, displaying information representative of a leg of the trip of the cargo shipment that is associated with the operator selection, and/or displaying different portions of the graphical representation of the cargo shipment in different manners representative of the one or more modes of transportation.

In one aspect, displaying the graphical representation includes displaying a straight line on a map of a transportation network formed from interconnected routes, where the straight line extends from the origin location on the map to the destination location.

In one aspect, the straight line that is displayed deviates from the routes displayed on the map.

In one aspect, the one or more modes of transportation include two or more of rail transportation, marine vessel transportation, air transportation, and/or automobile transportation.

In one aspect, the different portions of the graphical representation of the cargo shipment are displayed in different manners by displaying the different portions in one or more of different colors, using different lines, or using different shapes based on the one or more modes of transportation associated with the different portions of the graphical representation of the cargo shipment.

In one embodiment, a method (e.g., for monitoring a transportation network) includes receiving selection of one or more incoming data fields in an incoming data structure, the one or more incoming data fields representing different types of data that are provided by one or more data providers via a web service to a monitoring system, determining whether one or more of a name or hierarchy of the one or more incoming data fields that are selected are to be changed, and generating a mapped data structure comprising one or more mapped data fields. The one or more mapped data fields can correspond to the one or more incoming data fields that are selected with the one or more of the name or hierarchy that is determined to be changed. The mapped data structure can be used to determine which of the data provided by the one or more data providers are to be communicated to the monitoring system in the one or more mapped data fields.

In one aspect, the method also includes mapping the data received in the one or more incoming data fields that are selected to the one or more mapped data fields and using the data received in the one or more incoming data fields that are selected for tracking movement of one or more of vehicles or cargo within a transportation network.

In one aspect, the mapped data structure is customized for the monitoring system.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f), unless and until such claim limitations expressly use the phrase “means for” followed by a statement of function void of further structure.

This written description uses examples to disclose several embodiments of the inventive subject matter and also to enable a person of ordinary skill in the art to practice the embodiments of the inventive subject matter, including making and using any devices or systems and performing any incorporated methods. The patentable scope of the inventive subject matter is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand-alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

What is claimed is:

1. A system comprising:
one or more processors configured to receive data relating to vehicles associated with a transportation network formed from interconnected routes;
wherein the one or more processors are further configured, based at least in part on the data, to determine origin and destination pairs for different vehicle systems formed from different groups of the vehicles and traveling in the transportation network, to identify the vehicles included in the different vehicle systems, and to direct one or more display devices to display different graphical representations of the vehicle systems based on the vehicles included in the vehicle systems on a map of the transportation network that is displayed on one of the one or more display devices.

2. The system of claim 1, wherein the one or more processors are configured to determine the origin and destination pairs for the vehicle systems, for at least one of the vehicle systems, by identifying an origin location where the vehicles in the vehicle system begin a trip to a destination location and a destination location where the vehicles in the vehicle system end the trip.

3. The system of claim 1, wherein the one or more processors are configured to direct the one or more display devices to display the graphical representations of the vehicle systems by displaying one or more of different sized representations or differently colored representations for the different vehicle systems.

4. The system of claim 1, wherein the one or more processors are configured to receive an operator selection, via one or more input devices, of at least one of the graphical representations via an input device and, responsive to receiving the operator selection, the one or more processors are configured to direct the display device to display information representative of the vehicles in the vehicle system associated with the operator selection of the at least one of the graphical representations.

5. The system of claim 1, wherein the one or more processors are configured to identify the vehicles by determining a baseline group of the vehicles included in at least one of the vehicle systems based on one or more of an operator-customized criterion or a history of one or more previous trips of the vehicles.

6. The system of claim 1, wherein the one or more processors also are configured to direct the one or more display devices to display different graphical representations of the routes of the transportation network on the map that is displayed on the display device.

7. A method comprising:
determining origin and destination pairs for different vehicle systems formed from different groups of vehicles and traveling in a transportation network formed from interconnected routes;
identifying the vehicles included in the different vehicle systems; and
displaying different graphical representations of the vehicle systems based on the vehicles included in the vehicle systems on a map of the transportation network that is displayed on a display device.

8. The method of claim 7, wherein determining the origin and destination pairs for the vehicle systems includes, for at least one of the vehicle systems, identifying an origin location where the vehicles in the vehicle system begin a trip to a destination location and a destination location where the vehicles in the vehicle system in the trip.

9. The method of claim 7, wherein displaying the graphical representations of the vehicle systems includes displaying one or more of different sized representations or differently colored representations for the different vehicle systems.

10. The method of claim 7, further comprising receiving an operator selection of at least one of the graphical representations via an input device and, responsive to receiving the operator selection, displaying information representative of the vehicles in the vehicle system associated with the operator selection of the at least one of the graphical representations.

11. The method of claim 7, wherein identifying the vehicles includes determining a baseline group of the vehicles included in at least one of the vehicle systems based on one or more of an operator-customized criterion or a history of one or more previous trips of the vehicles.

12. The method of claim 7, further comprising displaying different graphical representations of the routes of the transportation network on the map that is displayed on the display device.

13. A method comprising:
determining an origin location and a destination location for a trip of a cargo shipment;
determining one or more modes of transportation of the cargo shipment from the origin location to the destination location;
displaying a graphical representation of the cargo shipment from the origin location to the destination location on a display device; and
one or more of:
responsive to receiving an operator selection of at least part of the graphical representation of the cargo shipment, displaying information representative of a leg of the trip of the cargo shipment that is associated with the operator selection; or
displaying different portions of the graphical representation of the cargo shipment in different manners representative of the one or more modes of transportation.

14. The method of claim 13, wherein displaying the graphical representation includes displaying a straight line on a map of a transportation network formed from interconnected routes, the straight line extending from the origin location on the map to the destination location.

15. The method of claim 14, wherein the straight line that is displayed deviates from the routes displayed on the map.

16. The method of claim 13, wherein the one or more modes of transportation include two or more of rail transportation, marine vessel transportation, air transportation, or automobile transportation.

17. The method of claim 13, wherein the different portions of the graphical representation of the cargo shipment are displayed in different manners by displaying the different portions in one or more of different colors, using different lines, or using different shapes based on the one or more modes of transportation associated with the different portions of the graphical representation of the cargo shipment.

18. A method comprising:
receiving selection of one or more incoming data fields in an incoming data structure, the one or more incoming data fields representing different types of data that are provided by one or more data providers via a web service to a monitoring system;
determining whether one or more of a name or hierarchy of the one or more incoming data fields that are selected are to be changed; and
generating a mapped data structure comprising one or more mapped data fields, the one or more mapped data fields corresponding to the one or more incoming data fields that are selected with the one or more of the name or hierarchy that is determined to be changed, wherein the mapped data structure is used to determine which of the data provided by the one or more data providers are to be communicated to the monitoring system in the one or more mapped data fields.

19. The method of claim 18, further comprising mapping the data received in the one or more incoming data fields that are selected to the one or more mapped data fields and using the data received in the one or more incoming data fields that are selected for tracking movement of one or more of vehicles or cargo within a transportation network.

20. The method of claim 19, wherein the mapped data structure is customized for the monitoring system.
